(19) United States
(12) Patent Application Publication
(10) Pub. No.: US 2015/0014052 A1
(43) Pub. Date: Jan. 15, 2015

(54) WIRE HARNESS AND METHOD FOR MANUFACTURING WIRE HARNESS

(71) Applicant: SUMITOMO WIRING SYSTEMS, LTD., Mie (JP)

(72) Inventors: Toru Matsuda, Mie (JP); Takaaki Fukui, Mie (JP)

(21) Appl. No.: 14/380,226

(22) PCT Filed: Dec. 27, 2012
(86) PCT No.: PCT/JP2012/083869

§ 371 Date: Aug. 21, 2014

(30) Foreign Application Priority Data
Mar. 9, 2012 (JP) 2012-052566

(51) Int. Cl. H01B 7/00; H01B 13/06

(52) U.S. Cl. CPC H01B 7/0045; H01B 13/06
USPC 174/72 A; 156/54

(57) ABSTRACT

A wire harness has a wire bundle and a covering member formed of a hot-pressed nonwoven member and covering the wire bundle. The covering member has a plurality of first portions extending in an extending direction of the wire bundle and at least one second portion extending in the extending direction of the wire bundle and being softer than the plurality of first portions. The first portions and the second portion of the covering member are provided alternately in a circumferential direction of the wire bundle. The covering member is bent at the at least one second portion in the circumferential direction of the wire bundle.

### TECHNICAL FIELD

The present invention relates to a wire harness.

### BACKGROUND ART

Various technologies have conventionally proposed for wire harnesses. Patent Literature 1, for example, discloses a wire harness in which a wire bundle is covered by a covering member. The covering member disclosed in Patent Literature 1 is produced by hot-pressing a nonwoven member.

### CITATION LIST

### Patent Literature

Patent Literature 1: Japanese Patent Laid-Open Publication No. 2011-210508

### SUMMARY OF INVENTION

### Technical Problem

In the wire harness, when an outer shape of the covering member that covers the wire bundle varies for each product, the wire harness is likely to interfere with surroundings.

In view of the above, an object of the present invention is to provide a technology capable of reducing product variation in an outer shape of a covering member that covers a wire bundle.

### Solution to Problem

A first aspect provides a wire harness having a wire bundle and a covering member formed of a hot-pressed nonwoven member and covering the wire bundle. The covering member has a plurality of first portions extending in an extending direction of the wire bundle and at least one second portion extending in the extending direction of the wire bundle and being softer than the plurality of first portions. The first portions and the second portion of the covering member are provided alternately in a circumferential direction of the wire bundle. The covering member is bent at the at least one second portion in the circumferential direction of the wire bundle.

A second aspect provides the wire harness according to the first aspect, in which the at least one second portion is provided in plurality.

A third aspect provides the wire harness according to the first aspect, in which a certain first portion included in the plurality of first portions has an inner surface harder than an outer surface.

A fourth aspect provides the wire harness according to the third aspect, in which, in the plurality of first portions, another first portion than the certain first portion has both an inner surface and an outer surface harder than the outer surface of the certain first portion.

A fifth aspect provides a method of producing a wire harness, including (a) hot-pressing a nonwoven member to produce a covering member; and (b) covering a wire bundle with the covering member produced in (a). The covering member has a plurality of first portions extending in a predetermined direction and at least one second portion extending in the predetermined direction and being softer than the plurality of first portions. The first portions and the second portion of the covering member are provided alternately. In (b), the covering member is bent at the at least one second portion so as to cover the wire bundle.

A sixth aspect provides the method of producing the wire harness according to the fifth aspect, in which, in (a), the nonwoven member is hot-pressed in a state of being held between a first mold and a second mold, at least one of which is heated; and a recess is provided to each of an opposite surface to the second mold in the first mold and an opposite surface to the first mold in the second mold, the recess having a shape associated with a shape of the second portion.

A seventh aspect provides the method of producing the wire harness according to the sixth aspect, in which a certain first portion included in the plurality of first portions of the covering member has a first main surface harder than a second main surface. In (a), a region corresponding to the first main surface of the certain first portion in a first main surface of the nonwoven member is heated more than a region corresponding to the second main surface of the certain first portion in a second main surface of the nonwoven member. In (b), the wire bundle is covered by the covering member such that the first main surface and the second main surface of the certain first portion are provided as an inner surface and an outer surface, respectively.

An eighth aspect provides the method of producing the wire harness according to the seventh aspect, in which, in the plurality of first portions, another first portion than the certain first portion has both a first main surface and a second main surface harder than the second main surface of the certain first portion; and, in (a), a region corresponding to the first main surface of the another first portion in the first main surface of the nonwoven member and a region corresponding to the second main surface of the another first portion in the second main surface of the nonwoven member are heated more than the region corresponding to the second main surface of the certain first portion in the second main surface of the nonwoven member.

### Advantageous Effects of Invention

According to the first to eighth aspects, the covering member has the soft second portion, which facilitates bending of the covering member thereat. Thus, the covering member can be readily bent. In addition, a bending position of the covering member is stabilized, thus reducing product variation in an outer shape of the covering member in the wire harness.

According to the second aspect in particular, the covering member has a plurality of soft second portions, which allow the covering member to be bent at each thereof. This enables easy production of a covering member having substantially a polygonal outer shape in cross section.

According to the third aspect in particular, the covering member has the first portion where the inner surface is harder than the outer surface. This protects the wire bundle as well as prevents noise from being generated when the covering member interferes with surroundings.

According to the fourth aspect in particular, the covering member has the first portion where both the inner surface and outer surface are hard. Thus, the covering member has a portion resistant to interference from surroundings. By placing the portion resistant to interference from surroundings in a location where a strong interference with surroundings occurs, the wire bundle can be reliably protected from the strong interference.

According to the sixth aspect in particular, the recess having the shape associated with the shape of the second portion is provided to each of the opposite surface to the second mold in the first mold and the opposite surface to the first mold in the second mold. Thus, when the nonwoven member is hot-pressed in the state of being held between the first mold and the second mold, an amount of heat transferred to the portion of the nonwoven member 100 held between the recess of the first mold and the recess of the second mold can be reduced. Thus, the soft second portion of the covering member can be readily produced.

According to the seventh aspect in particular, the region corresponding to the first main surface of the first portion having the first main surface harder than the second main surface in the first main surface of the nonwoven member is heated more than the region corresponding to the second main surface of the first portion in the second main surface of the nonwoven member. Thus, the first portion can be readily produced, the first portion having the inner surface harder than the outer surface when the wire bundle is covered by the covering member.

According to the eighth aspect in particular, the region corresponding to the first main surface of the first portion where both the first main surface and second main surface are hard in the first main surface of the nonwoven member and the region corresponding to the second main surface of the first portion in the second main surface of the nonwoven member are heated more than the region corresponding to the second main surface of the first portion where the first main surface is harder than the second main surface in the second main surface of the nonwoven member. Thus, the first portion can be readily produced, the first portion having the both hard inner surface and outer surface when the wire bundle is covered by the covering member.

A purpose, features, aspects, and advantages of the present invention will be more clarified in the detailed description below with reference to the attached drawings.

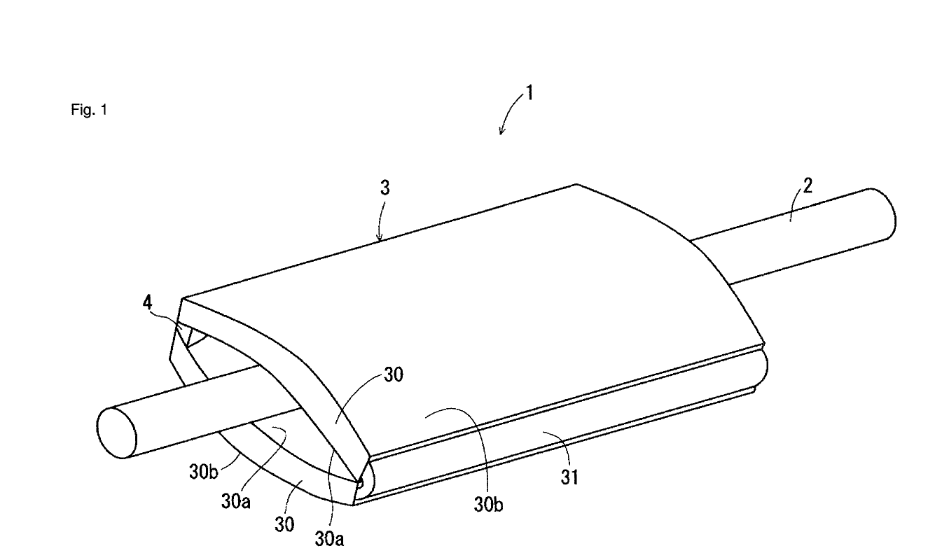

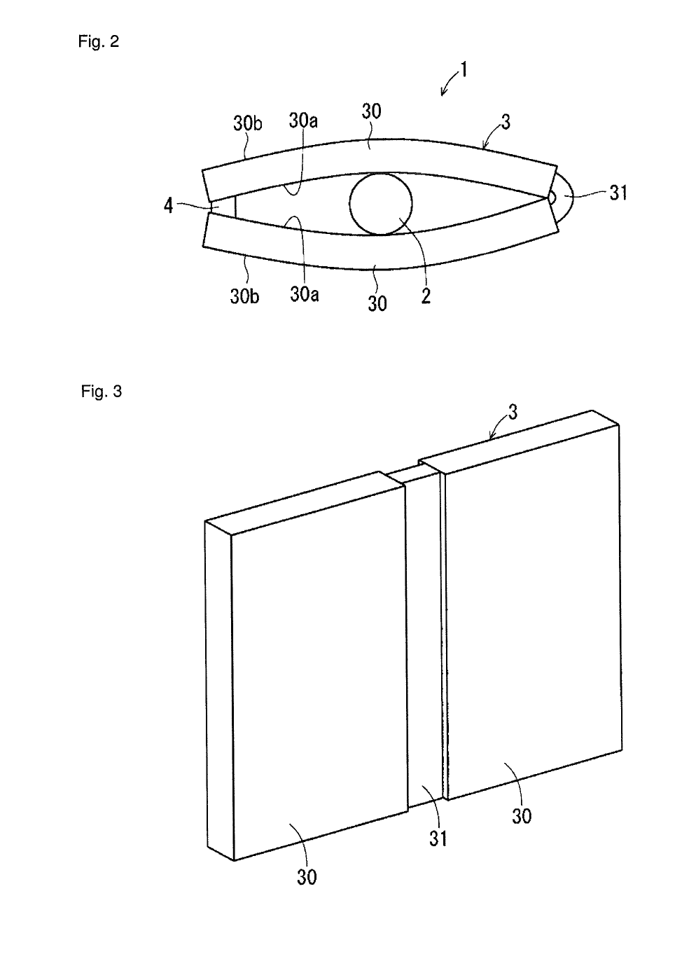

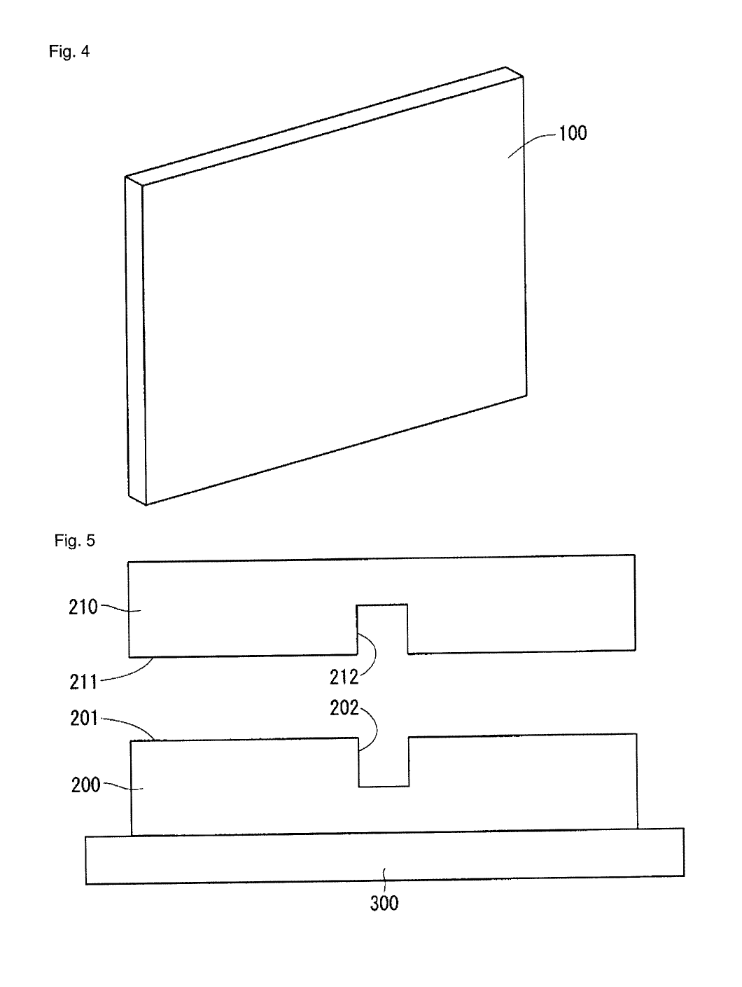

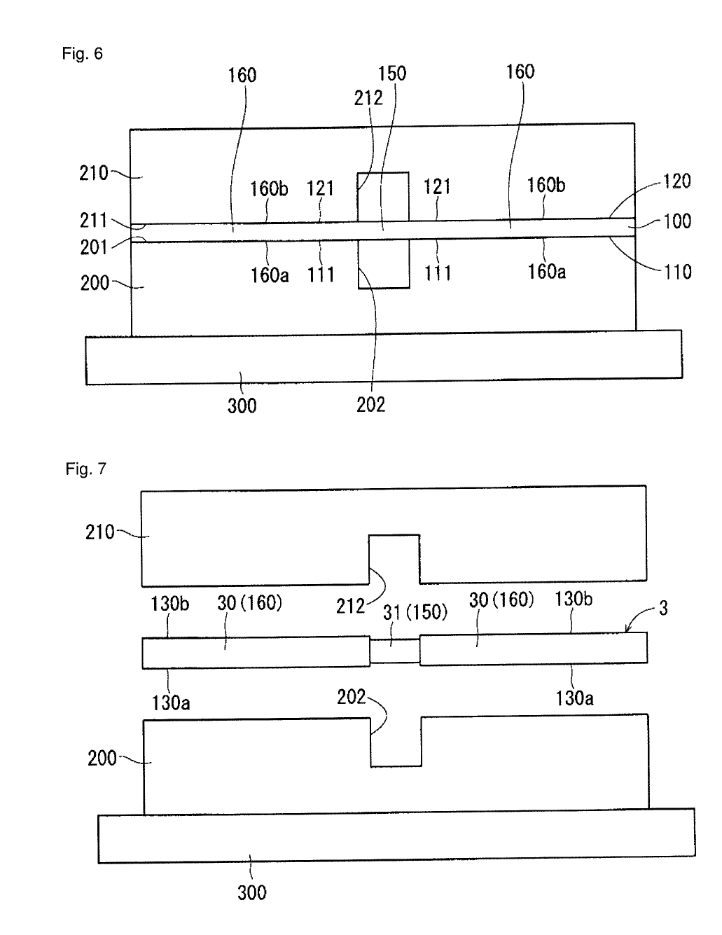

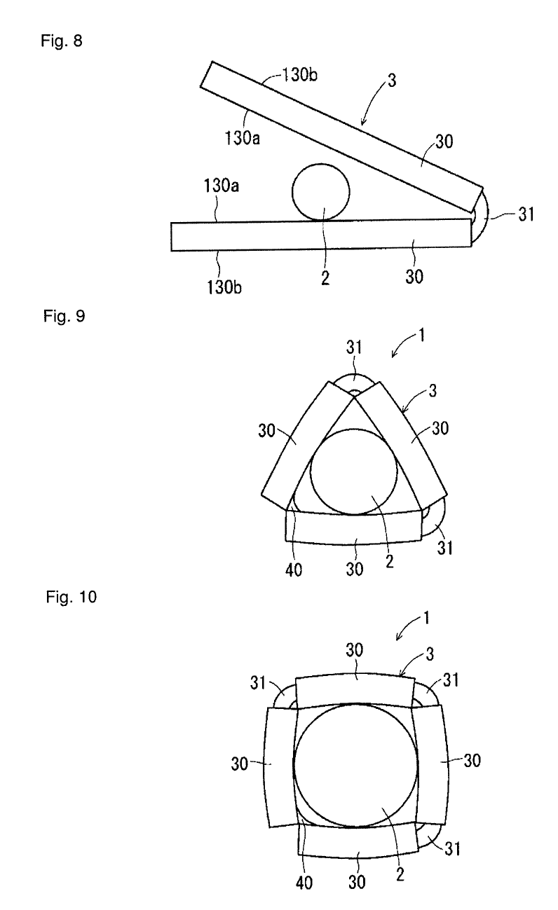

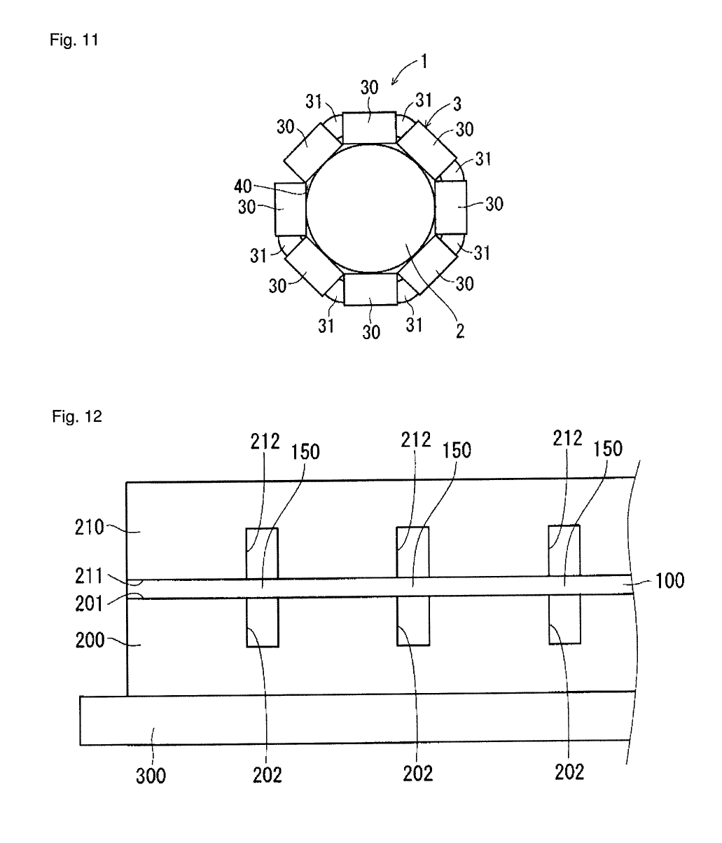

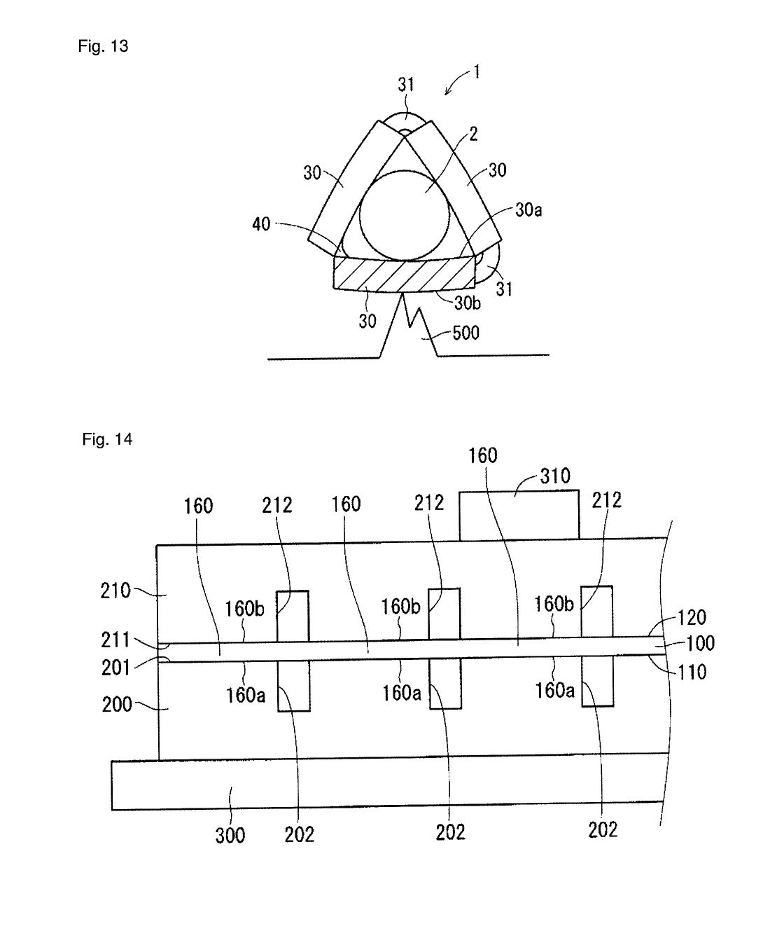

### BRIEF DESCRIPTION OF DRAWINGS

[FIG. 1] A perspective view of a wire harness.

[FIG. 2] A side view of the wire harness.

[FIG. 3] A perspective view of a covering member before being bent.

[FIG. 4] A perspective view of a nonwoven member.

[FIG. 5] A side view of a lower mold and an upper mold.

[FIG. 6] A view illustrating a state in which the nonwoven member is hot-pressed.

[FIG. 7] A side view illustrating a state immediately after the covering member is produced.

[FIG. 8] A view illustrating a state in which the covering member is bent so as to cover a wire bundle.

[FIG. 9] A side view illustrating a modified example of a wire harness.

[FIG. 10] A side view illustrating a modified example of a wire harness.

[FIG. 11] A side view illustrating a modified example of a wire harness.

[FIG. 12] A view illustrating a state in which the nonwoven member is hot-pressed.

[FIG. 13] A view illustrating a state in which a hard portion where both an inner surface and an outer surface are hard faces a pointed interfering object.

[FIG. 14] A view illustrating a state in which the nonwoven member is hot-pressed.

### DESCRIPTION OF EMBODIMENTS

FIG. 1 is a perspective view of a wire harness 1 according to an embodiment. FIG. 2 is a side view of the wire harness 1 viewed from a longitudinal direction of the wire harness 1. The wire harness 1 according to the embodiment is routed in a vehicle, such as an automobile, for example.

With reference to FIGS. 1 and 2, the wire harness 1 has a wire bundle 2 in which a plurality of electric wires are bundled and a covering member 3 covering the wire bundle 2. The covering member 3 is bent in two so as to cover the wire bundle 2. FIG. 3 is a perspective view of the covering member 3 before being bent. The covering member 3 is attached to the wire bundle 2 in a state of having the wire bundle 2 therebetween. The covering member 3 regulates a path of the wire bundle 2 when the wire harness 1 is routed in the vehicle or the like, and protects the wire bundle 2 from an interfering object surrounding the wire harness 1.

The covering member 3 has two first portions 30 and a second portion 31, the first portions 30 extending in an extending direction of the wire bundle 2, the second portion 31 extending in the extending direction of the wire bundle 2 and being softer than the plurality of first portions 30. Each of the first portions 30 has a sufficiently larger surface area than a surface area of the second portion. The two first portions 30 are main portions of the covering member 3. Each of the first portions 30 and the second portion 31 are provided from end to end of the covering member 3 in the extending direction of the wire bundle 2. The relatively hard first portions 30 are hereinafter referred to as the “hard portions 30” and the relatively soft second portion 31 as the “soft portion 31.”

In the covering member 3, the hard portions 30 and the soft portion 31 are provided alternately in a circumferential direction of the wire bundle 2. Specifically, the two hard portions 30 and the one soft portion 31 are provided in a sequence of the hard portion 30, the soft portion 31, and the hard portion 30 in the circumferential direction of the wire bundle 2. The covering member 3 is bent at the soft portion 31 in the circumferential direction of the wire bundle 2. In other words, the soft portion 31 serves as a hinge that connects the two hard portions 30. The covering member 3 is then bent in two such that end portions of the two hard portions 30 (end portions opposite to end portions connected to the soft portion 31) are opposite to each other. The end portions of the two hard portions 30 opposite to each other adhere to each other with a double-sided adhesive tape 4, for instance. That is, the two end portions of the covering member 3 in the circumferential direction of the wire bundle 2 adhere to each other with the double-sided adhesive tape 4. Accordingly, the wire bundle 2 is covered by the covering member 3 so as to be held between the two hard portions 30. In the present embodiment, in order to prevent displacement of the covering member 3 when the covering member 3 is attached to the wire bundle 2, the wire bundle 2 is provided between the two hard portions 30 such that the two hard portions 30 are pressed against the wire bundle 2. Thus, each hard portion 30 is slightly curved.

The covering member 3 is formed of a hot-pressed nonwoven member (nonwoven fabric, for instance). Hot-pressing herein refers to a process in which a nonwoven member is held between molds and is molded by pressuring the molds in a heated state. A nonwoven member that can be hardened in a heating process can be used for the nonwoven member. Such a nonwoven member includes elementary fiber and adhesive resin (also referred to as binder) interwoven therewith. The adhesive resin has a lower melting point (for example, 110° C. to 115° C.) than that of the elementary fiber. The nonwoven member is heated at a processing temperature lower than the melting point of the elementary fiber and higher than the melting point of the adhesive resin, and then the adhesive resin melts and seeps in between the elementary fibers. Thereafter, the temperature of the nonwoven member lowers below the melting point of the adhesive resin, and then the adhesive resin is solidified in a state where the elementary fibers are bound together. Thus, the nonwoven member becomes harder than in a pre-heating state and is maintained in a shape formed at the time of heating.

Any fiber capable of maintaining a fibrous state at the melting point of the adhesive resin can be used as the elementary fiber. Other than a resin fiber, various kinds of fibers can be used. Furthermore, a thermoplastic resin fiber, which has a melting point lower than the elementary fiber, can be used as the adhesive resin. The adhesive resin may be granular or fibrous. Alternatively, a binder fiber may be provided by forming an adhesive resin layer around an outer periphery of a core fiber and be interwoven with the elementary fiber. The core fiber in this case can be the same material as the elementary fiber.

An exemplary combination of the elementary fiber and the adhesive resin may include a resin fiber composed of PET (polyethylene terephthalate) as the elementary fiber and a copolymer resin composed of PET and PEI (polyethylene isophthalate) as the adhesive resin. In this case, the melting point of the elementary fiber is approximately 250° C., while the melting point of the adhesive resin is 110° C. to 150° C. Thus, when the nonwoven member is heated at a temperature of 110° C. to 250° C., the adhesive resin melts and seeps in between the elementary fibers, which do not melt and hold a fibrous shape. When the temperature of the nonwoven member then lowers below the melting point of the adhesive resin, the adhesive resin is solidified in a state where the elementary fibers are bound together, and the nonwoven member is hardened and maintained in a shape formed at the time of heating.

Each hard portion 30 of the covering member 3 has an inner surface 30a (main surface on the wire bundle 2 side) harder than an outer surface 30b (main surface on a reverse side of the wire bundle 2). In the prevent embodiment, since the inner surface 30a of the hard portion 30 of the covering member 3 is hard, the wire bundle 2 can be protected from an interfering object around the routed wire harness 1. In addition, since the outer surface 30b of the hard portion 30 of the covering member 3 is soft, noise can be prevented from being generated even when the interfering object around the routed wire harness 1 hits the covering member 3.

In the present embodiment, since the covering member 3 formed of the hot-pressed nonwoven member has the soft portion 31 extending in the extending direction of the wire bundle 2, the covering member 3 is readily bent at the soft portion 31.

In contrast, in a case where no soft portion 31 is provided to the covering member 3, different from the present embodiment, specifically, in a case where the covering member 3 has substantially even hardness, the covering member 3 is difficult to bend. Furthermore, a bending position of the covering member 3 is likely to vary, and thus an outer shape of the covering member 3 is likely to vary for each product.

In the wire harness 1 according to the present embodiment, the covering member 3 is readily bent at the soft portion 31, and thus the bending position of the covering member 3 is stabilized. Accordingly, product variation is reduced in the outer shape of the covering member 3 of the wire harness 1. As a result, the wire harness 1 is prevented from interfering with surroundings.

Furthermore, in the present embodiment, the inner surface 30a is harder than the outer surface 30b in the hard portion 30 of the covering member 3. This protects the wire bundle 2 and prevents noise from being generated when the covering member 3 interferes with surroundings.

A method of producing the wire harness 1 according to the present embodiment is described below. FIG. 4 is a perspective view of an example of a nonwoven member 100 used in production of the covering member 3. FIG. 5 is a side view of a lower mold 200 and an upper mold 210 used to produce the covering member 3 by hot-pressing the nonwoven member 100.

With reference to FIG. 4, the nonwoven member 100 has a rectangular sheet shape, for example. In the present embodiment, the nonwoven member 100 is hot-pressed in a state of being held between the lower mold 200, which is heated by a heater 300, and the upper mold 210, which is not heated.

With reference to FIG. 5, the lower mold 200 is placed on the heater 300, which heats an entirety of the lower mold 200. Meanwhile, no heater is provided to the upper mold 210, which is thus not heated. In an upper surface of the lower mold 200, specifically, an opposite surface 201 to the upper mold 210 in the lower mold 200, a recess 202 is provided, the recess 202 having a shape associated with a shape of the soft portion 31 of the covering member 3 (more accurately, the soft portion 31 of the covering member 3 before being bent). The recess 202 has a straight groove shape, which extends from end to end of the opposite surface 201. A width of the recess 202 matches a width of the soft portion 31 of the covering member 3 (more accurately, the soft portion 31 of the covering member 3 before being bent).

Similarly, in a lower surface of the upper mold 210, specifically, an opposite surface 211 to the lower mold 200 in the upper mold 210, a recess 212 is provided, the recess 212 having a shape associated with the shape of the soft portion 31 of the covering member 3. The recess 212 has a straight groove shape, which extends from end to end of the opposite surface 211. A width of the recess 212 matches the width of the soft portion 31 of the covering member 3.

When the nonwoven member 100 is hot-pressed with the lower mold 200 and the upper mold 210, the nonwoven member 100 is inserted between the lower mold 200 and the upper mold 210, as shown in FIG. 6, such that the recesses 202 and 212 face each other with the nonwoven member 100 therebetween. At this time, the recesses 202 and 212 cover the nonwoven member 100 from end to end in extending directions thereof. In a state where the entire lower mold 200 is heated by the heater 300, the lower mold 200 and the upper mold 210 are pressured. Thus, the nonwoven member 100 is pressured in a heated state. Thereby, the nonwoven member 100 is hot-pressed in the state of being held between the lower mold 200 and the upper mold 210. Alternatively, instead of heating the entire lower mold 200, the entire upper mold 210 may be heated.

During hot-pressing of the nonwoven member 100, a portion held between the recesses 202 and 212 in the nonwoven member 100, specifically, a mold non-contact portion 150, which is not in contact with the lower mold 200 and the upper mold 210 (refer to FIG. 6), is not pressured and hardly heated. Thus, even when the nonwoven member 100 is hot-pressed, a physical property of the mold non-contact portion 150 hardly changes from that of the nonwoven member 100 before molding. Specifically, the mold non-contact portion 150 remains soft without hardening so much. After the nonwoven member 100 is hot-pressed, the mold non-contact portion 150 is provided as the soft portion 31, as shown in FIG. 7.

In contrast, in the nonwoven member 100, two mold contact portions 160, which are in contact with the lower mold 200 and the upper mold 210 and have the mold non-contact portion 150 therebetween (refer to FIG. 6), are pressured and sufficiently heated. Thus, each mold contact portion 160 sufficiently hardens. In the nonwoven member 100, the two mold contact portions 160 having the mold non-contact portion 150 therebetween are respectively provided as the hard portions 30, as shown in FIG. 7.

In the nonwoven member 100, a thickness of the heated portions tends to be greater than that of the non-heated portion. Since the mold contact portions 160 are heated more than the mold non-contact portion 150, a thickness of the hard portions 30 is greater than that of the soft portion 31.

In the present embodiment, the lower mold 200 is heated while the upper mold 210 is not heated. Thus, in the nonwoven member 100, a first main surface 110, which is in contact with the lower mold 200, is heated more than a second main surface 120, which is in contact with the upper mold 210. More specifically, a region 111 in contact with the lower mold 200 in the first main surface 110 of the nonwoven member 100 is heated more than a region 121 in contact with the upper mold 210 in the second main surface 120 of the nonwoven member 100. As a result, the region 111 is harder than the region 121. In other words, in each mold contact portion 160 of the nonwoven member 100, a first main surface 160a which is in contact with the lower mold 200 is heated more than a second main surface 160b which is in contact with the upper mold 210. As a result, the first main surface 160a is harder than the second main surface 160b. Accordingly, in the hard portion 30 of the covering member 3, a first main surface 130a corresponding to the first main surface 160a (refer to FIG. 7) is harder than a second main surface 130b corresponding to the second main surface 160b (refer to FIG. 7).

Thus, in the present embodiment, the first main surface 160a of the mold contact portion 160, specifically, a region corresponding to the relatively hard first main surface 130a of the hard portion 30 in the first main surface 110 of the nonwoven member 100, is heated more than the second main surface 160b of the mold contact portion 160, specifically, a region corresponding to the relatively soft second main surface 130b of the hard portion 30 in the second main surface 120 of the nonwoven member 100.

After the covering member 3 is produced, the wire bundle 2 is covered by the covering member 3, as shown in FIG. 8, such that the first main surface 130a and the second main surface 130b of the hard portion 30 are provided as the inner surface and the outer surface, respectively. Thus, in the hard portion 30 of the covering member 3 of the finished wire harness 1, the inner surface 30a is harder than the outer surface 30b as described above.

According to the method of producing the wire harness 1 of the present embodiment described above, the recesses 202 and 212 each having the shape associated with the shape of the soft portion 31 are provided in the opposite surface 201 to the upper mold 210 in the lower mold 200 and the opposite surface 211 to the lower mold 200 in the upper mold 210, respectively. Thus, when the nonwoven member 100 is hot-pressed in the state of being held between the lower mold 200 and the upper mold 210, an amount of heat transferred to the portion held between the recesses 202 and 212 (mold non-contact portion 150) in the nonwoven member 100 can be reduced. Thus, the soft portion 31 can be readily produced.

Furthermore, in the present embodiment, the region corresponding to the relatively hard first main surface 130a of the hard portion 30 in the first main surface 110 of the nonwoven member 100 is heated more than the region corresponding to the relatively soft second main surface 130b of the hard portion 30 in the second main surface 120 of the nonwoven member 100. Thus, the hard portion 30 can be readily produced, the hard portion 30 having the inner surface 30a harder than the outer surface 30b when the wire bundle 2 is covered by the covering member 3.

### Modified Examples

In the embodiment above, the covering member 3 has the two hard portions 30 and one soft portion 31. Alternatively, three or more hard portions 30 and two or more soft portions 31 may be provided. FIGS. 9 to 11 are each a side view illustrating a modified example of a wire harness 1. FIG. 9 illustrates a wire harness 1 having a covering member 3 that has three hard portions 30 and two soft portions 31. FIG. 10 illustrates a wire harness 1 having a covering member 3 that has four hard portions 30 and three soft portions 31. FIG. 11 illustrates a wire harness 1 having a covering member 3 that has eight hard portions 30 and seven soft portions 31.

In each of the covering members 3 of the wire harnesses 1 in the modified examples shown in FIGS. 9 to 11, the hard portions 30 and the soft portions 31 are provided alternately in the circumferential direction of the wire bundle 2, similar to the wire harness 1 shown in FIGS. 1 and 2. In each of the wire harnesses 1 in the modified examples, the covering member 3 is bent at the plurality of soft portions 31 in the circumferential direction of the wire bundle 2 such that the covering member 3 covers the wire bundle 2. In each of the wire harnesses 1 in the modified examples, two end portions in the circumferential direction of the wire bundle 2 adhere to each other with an adhesive tape 40 in the covering member 3 that surrounds the wire bundle 2.

In each of the wire harnesses 1 in the modified examples shown in FIGS. 9 to 11, a cross-sectional structure of the covering member 3 in a direction perpendicular to the extending direction of the wire bundle 2 has substantially a polygonal outer shape. In the wire harness 1 in the modified example shown in FIG. 9, the cross-sectional structure of the covering member 3 has substantially a triangle outer shape. In the wire harness 1 in the modified example shown in FIG. 10, the cross-sectional structure of the covering member 3 has substantially a rectangle outer shape. In the wire harness 1 in the modified example shown in FIG. 11, the cross-sectional structure of the covering member 3 has substantially an octagonal outer shape.

When the covering member 3 covers the wire bundle 2, each of the plurality of hard portions 30 of the covering member 3 is pressed against the wire bundle 2. Specifically, the covering member 3 is wrapped around the wire bundle 2 in a state where each of the hard portions 30 of the covering member 3 is pressed against the wire bundle 2. This prevents displacement of the covering member 3 attached to the wire bundle 2.

Accordingly, in the covering member 3, providing the plurality of soft portions 31 each serving as a hinge that connects the hard portions 30 allows easy production of the covering member having the cross-sectional structure that has substantially a polygonal outer shape.

To produce the covering member 3 having the plurality of soft portions 31, such as the covering members 3 of the wire harnesses 1 in the modified examples, as shown in FIG. 12, a plurality of recesses 202 and a plurality of recesses 212 can be provided to the lower mold 200 and the upper mold 210, respectively, which are used to hot-press the nonwoven member 100. Then, a plurality of portions held between the recesses 202 and 212 are provided to the nonwoven member 100 as mold non-contact portions 150. The covering member 3 having the plurality of soft portions 31 is thus produced.

In the examples above, the inner surfaces 30a are harder than the outer surfaces 30b in the plurality of hard portions 30 of the covering member 3. Alternatively, both the inner surfaces 30a and the outer surfaces 30b may be hard. To produce the covering member 3 having hard portions 30 where both the inner surfaces 30a and the outer surfaces 30b are hard, a heater may be attached to the upper mold 210 as well to heat not only the entire lower mold 200, but also the entire upper mold 210 when the nonwoven member 100 is hot-pressed.

Furthermore, the covering member 3 may have both the hard portion 30 where the inner surface 30a is hard and the outer surface 30b is soft (hereinafter referred to as “first hard portion 30”) and the hard portion 30 where both the inner surface 30a and the outer surface 30b are hard (hereinafter referred to as “second hard portion 30”). In other words, the covering member 3 may have the first hard portion 30 and the second hard portion 30 where both the inner surface 30a and the outer surface 30b are harder than the soft outer surface 30b of the first hard portion 30.

When both the inner surface 30a and the outer surface 30b are hard in the hard portion 30 of the covering member 3, the covering member 3 has the hard portion 30 resistant to interference from surroundings. Thus, by placing the hard portion 30 resistant to interference from surroundings in a location where a strong interference with surroundings occurs, the wire bundle 2 can be reliably protected from the strong interference.

FIG. 13 illustrates a state in which the second hard portion 30 where both the inner surface 30a and the outer surface 30b are hard (hard portion 30 indicated by diagonal lines) is provided facing a pointed interfering object 500, which causes a strong interference. FIG. 13 illustrates a case where only one of the three hard portions 30 is the second hard portion 30 in the modified example of the wire harness 1 shown in FIG. 9 above.

In the covering member 3 before being bent, the hard portion 30 where the first main surface 130a, which serves as the inner surface 30a, is harder than the second main surface 130b, which serves as the outer surface 30b, is provided as the “first hard portion 30;” and the hard portion 30 where both the first main surface 130a and the second main surface 130b are hard is provided as the “second hard portion 30.”

To produce the covering member 3 having the first hard portion 30 and the second hard portion 30, as shown in FIG. 14, a heater 310 is attached to the upper mold 210 so as to be opposite to only a portion of the mold contact portion 160 (one mold contact portion 160 in an example of FIG. 14) among a plurality of mold contact portions 160 in the nonwoven member 100. Thus, among the plurality of mold contact portions 160, both the first main surface 160a and the second main surface 160b of the mold contact portion 160 opposite to the heater 310 are heated via the upper mold 210. In other words, among the plurality of mold contact portions 160, both the first main surface 160a and the second main surface 160b of the mold contact portion 160 opposite to the heater 310 are heated more than the second main surface 160b of the mold contact portion 160 not opposite to the heater 310 among the plurality of mold contact portions 160. Thus, the mold contact portion 160 opposite to the heater 310 is provided as the second hard portion 30 where both the first main surface 130a and the second main surface 130b are hard.

Accordingly, the first main surface 160a of the mold contact portion 160 opposite to the heater 310, specifically, a region corresponding to the hard first main surface 130a of the second hard portion 30 in the first main surface 110 of the nonwoven member 100, and the second main surface 160b of the mold contact portion 160, specifically, a region corresponding to the hard second main surface 130b of the second hard portion 30 in the second main surface 120 of the nonwoven member 100, are heated more than the second main surface 160b of the mold contact portion 160 not opposite to the heater 310, specifically, a region corresponding to the soft second main surface 130b of the first hard portion 30 in the second main surface 120 of the nonwoven member 100. Thus, the second hard portion 30 can be readily produced.

In the examples above, the covering member 3 is wrapped around the wire bundle 2 only one time. Alternatively, the covering member 3 may have many hard portions 30 and soft portions 31 and the covering member 3 may be wrapped around the wire bundle 2 for a plurality of times by bending at the soft portions 31.

The detailed description above of the present invention is presented merely as an example in all aspects and should not limit the present invention. Innumerable modifications not presented are construed to be assumed without deviating from the scope of the present invention.

### REFERENCE SIGNS LIST

1: Wire harness

2: Wire bundle

3: Covering member

30: First portion

31: Second portion

30a: Inner surface

30b: Outer surface

100: Nonwoven member

130a: First main surface

130b: Second main surface

200: Lower mold

201, 211: Opposite surface

202, 212: Recess

210: Upper mold

1. A wire harness comprising:
a wire bundle; and
a covering member formed of a hot-pressed nonwoven member and covering the wire bundle,
the covering member comprising:
a plurality of first portions extending in an extending direction of the wire bundle; and
at least one second portion extending in the extending direction of the wire bundle and being softer than the plurality of first portions, wherein
the first portions and the second portion of the covering member are provided alternately in a circumferential direction of the wire bundle,
the covering member is bent at the at least one second portion in the circumferential direction of the wire bundle, and
a certain first portion included in the plurality of first portions has an inner surface harder than an outer surface.

2. The wire harness according to claim 1, wherein a plurality of the second portions are provided.

3. (canceled)

4. The wire harness according to claim 1, wherein, in the plurality of first portions, another first portion than the certain first portion has both an inner surface and an outer surface harder than the outer surface of the certain first portion.

5. A method of producing a wire harness, comprising:
hot-pressing a nonwoven member to produce a covering member; and
covering a wire bundle with the covering member, wherein
the covering member comprises:
a plurality of first portions extending in a predetermined direction; and
at least one second portion extending in the predetermined direction and being softer than the plurality of first portions, wherein
the first portions and the second portion of the covering member are provided alternately, wherein
the covering member is bent at the at least one second portion so as to cover the wire bundle, wherein
a certain first portion included in the plurality of first portions of the covering member has a first main surface harder than a second main surface, wherein
during hot-pressing a region corresponding to the first main surface of the certain first portion in a first main surface of the nonwoven member is heated more than a region corresponding to the second main surface of the certain first portion in a second main surface of the nonwoven member, and wherein
the wire bundle is covered by the covering member such that the first main surface and the second main surface of the certain first portion are provided as an inner surface and an outer surface, respectively.

6. The method of producing the wire harness according to claim 5, wherein
the nonwoven member is hot-pressed in a state of being held between a first mold and a second mold, at least one of which is heated, and
a recess is provided to each of an opposite surface to the second mold in the first mold and an opposite surface to the first mold in the second mold, the recess having a shape associated with a shape of the second portion.

7. (canceled)

8. The method of producing the wire harness according to claim 5, wherein
in the plurality of first portions, another first portion than the certain first portion has both a first main surface and a second main surface harder than the second main surface of the certain first portion, and
during hot-pressing a region corresponding to the first main surface of the another first portion in the first main surface of the nonwoven member and a region corresponding to the second main surface of the another first portion in the second main surface of the nonwoven member are heated more than the region corresponding to the second main surface of the certain first portion in the second main surface of the nonwoven member.
